(19) United States
(12) Patent Application Publication
(10) Pub. No.: US 2021/0268838 A1
(43) Pub. Date: Sep. 2, 2021

(54) NON-PNEUMATIC TIRE

(71) Applicant: THE GOODYEAR TIRE & RUBBER COMPANY, Akron, OH (US)

(72) Inventors: Sebastien Willy Fontaine, Vichten (LU); Frederic Ngo, Mersch (LU); Armand Rene Gabriel Leconte, Insenborn (LU); Claude Ernest Felix Boes, Erpeldange-sur-Sûre (LU); Daniel Paul Luc Marie Hinque, Habay-la-Neuve (BE); Philippe Joseph Willy Proehs, Colmar-Berg (LU); Jean-Francois Vandeclee, Bastogne (BE); Romain Lamacz, Ligny Les Aire (FR)

(21) Appl. No.: 17/187,007

(22) Filed: Feb. 26, 2021

Related U.S. Application Data
(60) Provisional application No. 62/982,805, filed on Feb. 28, 2020.

(51) Int. Cl. B60C 7/18

(52) U.S. Cl. CPC B60C 7/18; B60C 2007/146

(57) ABSTRACT

The present invention is directed to a non-pneumatic tire comprising a hub portion, a ring member essentially concentrically arranged about the hub portion, a plurality of tread portions radially extending out of a radially outer surface of the ring member, and a plurality of spokes extending from a radially outer surface of the hub portion to a radially inner surface of the ring member for supporting the ring member on the hub portion. Moreover, the tire comprises a plurality of channels fluidly connecting the hub portion with radially inner sides of the tread portions. In addition, the present invention is directed to a kit comprising such a tire and a capsule receivable in the tire.

This application claims benefit of U.S. Provisional Patent Application Ser. No. 62/982,805, filed on Feb. 28, 2020. The teachings of U.S. Provisional Patent Application Ser. No. 62/982,805 are incorporated herein by reference in their entirety.

### FIELD OF THE INVENTION

The present invention relates to a non-pneumatic tire and to a tire kit comprising a non-pneumatic tire and a refilling capsule receivable in a hub of said tire.

### BACKGROUND OF THE INVENTION

Vehicle drivers must frequently change tires, for instance due to tire wear. In particular, this constitutes a challenge for large vehicle fleets in which the fleet owners have to ensure that thousands of tires are changed on a timely basis. In order to change tires, cars have to be driven to a garage in which the car is lifted, wheels are unmounted, tires are removed from the rim and replaced with new tires. Then the new wheels have to be balanced and remounted to the vehicle which is a time consuming process, in particular for the vehicle driver. It would be desirable to avoid this time consuming process or reduce at least the number of times a driver has to return to the garage for obtaining new tires. Even when considering non-pneumatic tires, which have recently been developed by multiple tire manufacturers, tires having worn treads still need to be replaced with new tires. Spending less time for changing tires would also reduce costs and increase the availability of vehicles, in particular in car and truck fleet applications. Thus, significant room for improvement is left, when considering the present practice of replacing worn tires.

### SUMMARY OF THE INVENTION

One object of the present invention may be to provide an advanced non-pneumatic tire.

Another objective of the present invention may be to provide a non-pneumatic tire which offers a high mileage service life.

Another object of the present invention may be to provide a tire which may receive new tread material without demounting the tire from the vehicle.

Another object of the present invention may be to provide a tire with a tread having an adjustable tread rubber formulation that can be changed as needed to accommodate seasonal weather conditions and/or driver preferences during normal use of the tire.

Thus, in a first aspect of the invention, a non-pneumatic tire is provided, the tire comprising a hub portion (or hub or central hub portion, in particular arranged about the axis of rotation of the tire), a ring member essentially concentrically arranged about the hub portion, and a plurality of tread portions radially extending out of (or protruding from) a radially outer surface of the ring member. Furthermore, the tire according to the present invention comprises a plurality of spokes extending from a radially outer surface of the hub portion to a radially inner surface of the ring member for supporting the ring member on the hub portion. Moreover, a plurality of channels fluidly connects the hub portion with radially inner sides (or surfaces) of the tread portions. In particular, such a tire construction allows for the delivery of a liquid polymer composition from the hub portion through the channels to the tread portions (in particular from radially below the tread portions). This liquid polymer composition then cures to regenerate or renew the tread of the tire.

In one embodiment, the hub portion comprises a reservoir for receiving a liquid (such as a liquid polymer composition), the reservoir being in fluid communication with the plurality of channels. Such a reservoir is easily refillable or replaceable with new reservoirs to provide for replenishment of the liquid polymer composition to allow for continuing supply of new tire tread.

In another embodiment, the spokes have rod-like shapes. In particular, the spokes may have a relatively thin diameter which may be within the range of 0.5 mm to 10 mm, and which is preferably within the range of 1 mm to 5 mm. Such spokes have the advantage that they leave space for channels to extend between the hub portion and the ring member (or in other words ring portion).

In another embodiment, the spokes may be flexible cables, preferably made of metal (such as high carbon steel or stainless steel), composite material, and/or carbon fiber-based material (a carbon fiber). The spokes may have similar dimensions as in the aforementioned embodiment. In such an embodiment the hub is suspended on the ring member.

In another embodiment, at least some of the channels extend between the spokes from the hub portion to the radially inner sides of the tread portions. This allows for a compact design of the tire. Also, such channels are protected by the adjacent spokes.

In yet another embodiment, one or more of the spokes are hollow and form portions of the channels. In other words, the spoke may be pipes (or rigid pipes) which have a double function, such as to transport liquid and to provide a support for the ring member on the hub.

In still another embodiment, the channels comprise a plurality of flexible tubes extending from the hub portion to the ring member. For instance, flexible tubes may ease the connection between the hub and further portions of the channels in the ring member.

In still another embodiment, the spokes are made of one or more of the following materials: reinforced and vulcanized rubber material, polymeric materials, fiber filled polymeric materials, carbon fiber-based material, composite material and metals. For example, the spokes can be comprised of fiberglass, glass fiber reinforced polycarbonate, fiber reinforced polyolefins, blends of syndiotactic-1,2-polybutadine with high impact polystyrene, polyurethanes, polyamides, high carbon steel, stainless steel, aluminum, magnesium-aluminum alloys, and the like.

In still another embodiment, the tire further comprises at least one check valve adapted to avoid flowback of liquid from the channels back into the reservoir. In particular, in an embodiment, the liquid rubber composition is oxygen curable so that flowback into a region which may be in contact with air may be undesirable. The terms rubber and elastomer may be used interchangeably herein unless indicated otherwise.

In still another embodiment, the reservoir comprises or is an exchangeable capsule or container. Thus, a liquid polymer composition may be provided in a capsule. Once the capsule is almost depleted it may be exchanged with a new one. In an alternative embodiment, the container may be fixedly installed in the hub portion and refillable through an inlet (which may preferably comprise a check valve avoiding flow of liquid back from the reservoir into the environment). In such an embodiment, it is further possible that new rubber material is provided to the tire by a mobile tank. In such a way, vehicles, such as cars and trucks, needing replenishment could be serviced at almost any venue, including homes, businesses, parking lots, or on public roads.

In still another embodiment, the fill status of the reservoir and/or the capsule could be visualized on the hub, and optionally sent to a mobile device such as a smart phone, or indicated on an on-board display within a vehicle. The quantity of liquid in the reservoir could also, optionally, be reported by electronic message to a remote location by telephone, text message, e-mail, or other electronic form to the vehicle owner or a fleet owner with details regarding the fill status of reservoirs or capsules.

In still another embodiment, the capsule further comprises at least one recloseable opening and/or valve, which can be opened and closed and which is adapted to be in fluid communication with the channels when inserted in the hub portion. Such an opening could have a door configured as a movable iris and/or a sliding door.

In still another embodiment, an inner volume of the capsule is under high pressure. For instance, the pressure is typically within the range of 2 bars to 10 bars and preferably between 2 bars and 5 bars. The exact pressure will depend on the actual application and vehicle but is similar to the tire pressure in a pneumatic tire.

In still another embodiment, the capsule and/or the hub portion comprises a plurality of valves adapted to close automatically upon removal of the capsule and/or upon a drop of pressure. A drop of pressure may for instance occur if a tread portion is seriously damaged. Optionally, each tread portion is provided via one valve and one liquid line with liquid polymer material. Alternatively, a group of tread portions could be provided by a common liquid line and valve with liquid polymer material.

In still another embodiment, the tire comprises pressuring means for pumping liquid out of the reservoir and through the channels. Thus, it is also possible to provide for instance electrical or hydraulic pumping means in the tire, driven either by the rotating motion of the tire or by electrical energy provided by the electrical power system of the vehicle.

In still another embodiment, the ring member comprises a plurality of recesses extending from a radially outer surface of the ring member through the ring member, such as in a radially inner direction, wherein each recess is covered, at a radially outer portion of the respective recess, by at least one of the tread portions, and wherein each of the recesses is, at a radially inner portion, in fluid communication with at least one of the channels. Thus, a tread portion can be continuously provided from below by new liquid polymer composition material. In a preferred embodiment, the liquid polymer material is oxygen curable so that radially upper regions of the tread are cured by ambient air and radially lower portions remain uncured. Oxygen may diffuse also a certain depth or range through the cured rubber material. If desirable, in order to accelerate the curing process catalysts and/or peroxide curing agents may be deployed. Peroxide curatives that can optionally be used will typically be utilized at a level of 0.5 to 2 parts by weight per 100 parts by weight of the liquid polymer. Some representative examples of peroxides that can be used include benzoyl peroxide, hydrogen peroxide, di-t-butyl peroxide, dicumyl peroxide, 2,4-dichlorobenzoyl peroxide, decanoyl peroxide, lauryl peroxide, cumene hydroperoxide, p-menthane hydroperoxide, t-butyl hydroperoxide, acetyl acetone peroxide, dicetyl peroxydicarbonate, t-butyl peroxyacetate, t-butyl peroxymaleic acid, t-butyl peroxybenzoate, acetyl cyclohexyl sulfonyl peroxide, and the like. Cumyl t-butyl peroxide and dicumyl peroxide are typically the preferred peroxide curing agents for use in the practice of this invention.

Liquid polymers that are useful in the practice of this invention are comprised of repeat units that are derived from at least one conjugated diolefin monomer. Some representative examples of such conjugated diolefin monomers include 1,3-butadiene, isoprene, piperylene, 2-methyl-1,3-pentadiene, 2-ethyl-1,3-butadiene, 4-butyl-1,3-pentadiene, 2,3-dimethyl-1,3-pentadiene, 1,3-hexadiene, 1,3-octadiene, 1-phenyl-1,3-butadiene, and the like. Additional monomers that are copolymerizable with conjugated diolefin monomers can also be incorporated into the liquid polymers used in the non-pneumatic tires of this invention. For instance, repeat units that are derived from vinyl aromatic monomers, such as styrene and α-methyl styrene can also be incorporated into the liquid polymers of this invention. It should be noted that a double bond is consumed in the polymerization of such monomers and that repeat units that are derived from a given monomer differ from the monomer in that the double bond is not present in the repeat unit of the polymer.

Liquid polymers usable in the non-pneumatic tires of this invention can typically contain at least 50 weight percent conjugated diolefin monomers. The liquid polymers of this invention will more typically contain at least 70 weight percent conjugated diolefin monomers and will generally contain at least 75 weight percent conjugated diolefin monomers. Vinyl aromatic monomers, such as styrene and α-methyl styrene, are the most common type of copolymerizable monomers that are employed in making the liquid polymers used in accordance with this invention. Such vinyl aromatic monomers are typically included at levels of less than about 35 weight percent, such as a level which is within the range of 5 weight percent to 32 weight percent, and typically which is within the range of about 20 weight percent to about 30 weight percent.

In cases where vinyl aromatic monomers are utilized, they can typically be incorporated into such liquid polymers at a level of 1 weight percent to 30 weight percent. In many cases, the vinyl aromatic monomer will be incorporated into the liquid polymer at a level of 20 weight percent to 25 weight percent. For instance, the liquid polymer can be comprised of repeat units that are derived from 70 weight percent to 99 weight percent of one or more conjugated diolefin monomers and 1 weight percent to 30 weight percent of a vinyl aromatic monomer. More typically, such liquid polymers will contain from 75 weight percent to 80 weight percent of one or more conjugated diolefin monomers and 20 weight percent to 25 weight percent vinyl aromatic monomers. For example, the liquid polymer can contain 40 weight percent isoprene repeat units, 40 weight percent 1,3-butadiene repeat units, and 20 weight percent styrene repeat units. In many cases, the liquid polymers of this invention will be comprised entirely of repeat units that are derived from one or more conjugated diolefin monomers. For instance, the liquid polymer can be a copolymer that is comprised entirely of repeat units of isoprene and 1,3-butadiene. In other cases, the liquid polymer can be a homopolymer of a single conjugated diolefin monomer. For example, the liquid polymer can be a polyisoprene homopolymer or a polybutadiene homopolymer. However, to attain desired tire tread performance characteristics, blends of two or more liquid rubbers will frequently be utilized. For instance, the liquid polymer composition can be comprised of a blend of liquid styrene-butadiene rubber and liquid polybutadiene rubber.

Liquid polymers which may be used in the non-pneumatic tires of this invention will typically have a weight average molecular weight that is within the range of 5,000 to 100,000 which can be measured with gel permeation chromatography (GPC) using polystyrene calibration standards according to ASTM 5296-11 or equivalent. A weight average molecular weight of at least 5,000 is required to attain needed physical properties. On the other hand, the weight average molecular weight of the polymer cannot be more than 100,000 or the polymer begins to become a solid and is not easily pumpable which is, of course, needed in the non-pneumatic tires of this invention. The liquid polyisoprene rubbers utilized in the practice of this invention will typically have a minimum weight average molecular weight of at least 10,000. In any case, it is preferred for the liquid polymers to have a weight average molecular weight that is within the range of 20,000 to 80,000. It is more preferred for the liquid polymers of this invention to have a weight average molecular weight that is within the range of 30,000 to about 50,000.

In one embodiment of this invention, the liquid polymers will be functionalized with an ether functionality to increase the tear strength and tensile strength of the cured polymer. Ether functionalization can be accomplished through a number of techniques which include, but are not limited to, functional initiation, functional termination, functional co-monomers (styrenics or diene based), post polymerization functionalization, or combinations thereof. One polymerization process that is ideally suited for the preparation of the ether-functionalized liquid PI polymer is anionic polymerization. However, it should be understood that numerous other polymerization techniques can be utilized.

The cure rate of the liquid polymers utilized in the non-pneumatic tires of this invention can be greatly enhanced by increasing the level of vinyl microstructure in the liquid rubber. In other words, the liquid rubber will cure faster upon exposure to oxygen in the air while remaining relatively stable before being exposed to oxygen. This unexpected benefit is attained at vinyl contents of greater than 10 percent and is further enhanced at vinyl contents of greater than 15 percent. To attain desired cure rates on exposure to oxygen in the air the liquid rubbers employed in the practice of this invention will typically have vinyl contents of greater that 30 percent, 40 percent, 50 percent, or even 60 percent. It is normally preferred for such liquid rubbers to have a vinyl microstructure content that is within the range of 20 percent to 70 percent with it being more preferred for the liquid rubber to have a vinyl microstructure content which is within the range of 30 percent to 50 percent.

The vinyl microstructure content of liquid rubbers can be increased by conducting the polymerization used in their synthesis in the presence of a polymerization modifier. Ethers and tertiary amines which act as Lewis bases are representative examples of polar modifiers that can be utilized. Some specific examples of typical polar modifiers include diethyl ether, di-n-propyl ether, diisopropyl ether, di-n-butyl ether, tetrahydrofuran, ditetrahydro-furylpropane, dioxane, ethylene glycol dimethyl ether, ethylene glycol diethyl ether, diethylene glycol dimethyl ether, diethylene glycol diethyl ether, triethylene glycol dimethyl ether, trimethylamine, triethylamine, N,N,N′,N′-tetramethylethylenediamine (TMEDA), N-methyl morpholine, N-ethyl morpholine, N-phenyl morpholine and the like.

The polymerization modifier can also be a 1,2,3-trialkoxybenzene or a 1,2,4-trialkoxybenzene. Some representative examples of 1,2,3-trialkoxybenzenes that can be used include 1,2,3-trimethoxybenzene, 1,2,3-triethoxybenzene, 1,2,3-tributoxybenzene, 1,2,3-trihexoxybenzene, 4,5,6-trimethyl-1,2,3-trimethoxybenzene, 4,5,6-tri-n-pentyl-1,2,3-triethoxybenzene, 5-methyl-1,2,3-trimethoxybenzene, and 5-propyl-1,2,3-trimethoxybenzene. Some representative examples of 1,2,4-trialkoxybenzenes that can be used include 1,2,4-trimethoxybenzene, 1,2,4-triethoxybenzene, 1,2,4-tributoxybenzene, 1,2,4-tripentoxybenzene, 3,5,6-trimethyl-1,2,4-trimethoxybenzene, 5-propyl-1,2,4-trimethoxybenzene, and 3,5-dimethyl-1,2,4-trimethoxybenzene. Dipiperidinoethane, dipyrrolidinoethane, tetramethylethylene diamine, diethylene glycol, ditetrahydrofurylpropane, dimethyl ether and tetrahydrofuran are representative of highly preferred modifiers of this type. U.S. Pat. No. 4,022,959 describes the use of ethers and tertiary amines as polar modifiers in greater detail. The utilization of 1,2,3-trialkoxybenzenes and 1,2,4-trialkoxybenzenes as modifiers is described in greater detail in U.S. Pat. No. 4,696,986. The teachings of U.S. Pat. No. 4,022,959 and U.S. Pat. No. 4,696,986 are incorporated herein by reference in their entirety.

The microstructure of the repeat units which are derived from conjugated diolefin monomers is also a function of the polymerization temperature and the amount of polar modifier present. For example, it is known that higher temperatures result in lower vinyl contents. Accordingly, the polymerization temperature, quantity of modifier and specific modifier selected will be determined with the ultimate desired microstructure of the liquid polymer being synthesized being kept in mind.

The vinyl microstructure content of the liquid polymer can also be increased by copolymerizing a monomer containing at least 2 vinyl groups into the polymer. A preferred monomer containing 2 vinyl groups is 1-ethenyl-4-(3-butenyl)benzene since it copolymerizes with conjugated diolefin monomers but does not form crosslinks that can lead to gel formation during polymerization.

Liquid rubber compositions that are suitable for use in the practice of this invention can be made by blending the liquid rubber or liquid rubbers with a suitable curative system such as (a) a hydrosilylation catalyst and a crosslinking agent or (b) a peroxide or hydroperoxide curative (as previously described). In cases where the curative system includes a combination of a hydrosilylation catalyst and a crosslinking agent, the crosslinking agent will typically be used at a level which is within the range of 0.5 phr (parts by weight per 100 parts by weight of the liquid rubber) to 30 phr. The crosslinking agent will preferably be present in the curable composition at a level which is within the range of 5 phr to 25 phr. The hydrosilylation catalyst will typically be employed at a level which is within the range of 1 ppmr (parts of metal catalyst by weight per 1,000,000 parts by weight of the liquid rubber) to 100 ppmr. The hydrosilylation catalyst will preferably be present in the curable composition at a level which is within the range of 10 ppmr to 50 ppmr. In curable compositions that are used in injection molding applications the crosslinking agent will normally be present at a level which is within the range of 2 phr to 5 phr and the hydrosilylation catalyst will normally be present at a level which is within the range of 15 ppmr to 30 ppmr. However, it should be noted that the exact level of crosslinking agent and catalyst required will depend upon the characteristics of the liquid rubber and will normally be decreased with increasing levels of vinyl microstructure content in the liquid rubber.

The crosslinking agents that can be used in the practice of this invention preferably have at least 2 hydrosilyl groups per molecule. Crosslinking agents of this type are described in detail in U.S. Pat. No. 6,087,456. The teachings of U.S. Pat. No. 6,087,456 are incorporated herein by reference with respect to teaching the type of crosslinking agent (curing agent) that can be utilized in the liquid rubber composition employed in the non-pneumatic tires of this invention. The crosslinking agent will typically be a tetrakis(dialkyl siloxy) silane, a tris(dialkyl siloxy) alkyl silane, or a tris (dialkyl siloxy) aryl silane. The crosslinking agent will more typically be tetrakis(dimethyl siloxy) silane, tris(dimethyl siloxy) methyl silane, or tris (dimethyl siloxy) phenyl silane.

A wide variety of hydrosilylation catalysts can be preferably used in making the liquid rubber compositions employed in the non-pneumatic tires of this invention. Some representative examples of suitable hydrosilylation catalysts include chloroplatinic acid, elemental platinum, solid platinum supported on a carrier (such as alumina, silica or carbon black), platinum-vinylsiloxane complexes, for instance, Ptₙ(ViMe₂SiOSiMe₂Vi)ₙ and Pt[(MeViSiO)₄]ₘ, platinum-phosphine complexes, such as Pt(PPh₃)₄ and Pt(PBU₃)₄, and platinum-phosphite complexes, such as Pt[P(OPh)₃]₄ and Pt[P(OBu)₃]₄, wherein Me represents methyl, Bu represents butyl, Vi represents vinyl and Ph represents phenyl, and n and m represent integers. The platinum-hydrocarbon complex described in the specification of U.S. Pat. Nos. 3,159,601 and 3,159,662, and the platinum-alcoholate catalyst described in the specification of U.S. Pat. No. 3,220,972 can also be used. The teaching of U.S. Pat. Nos. 3,159,601, 3,159,662, and 3,220,972 are incorporated herein by reference.

Hydrosilylation catalysts containing metals other than platinum can also be used in the liquid rubber compositions used in the practice of this. Some representative examples of such catalysts include: RhCl(PPh₃)₃, RhCl₃, Rh/Al₂O₃, RuCl₃, IrCl₃, FeCl₃, AlCl₃, PdCl₂.2H₂O, NiCl₂, TiCl₄, and the like. These catalysts can be used alone or in combination. In view of catalytic activity, chloroplatinic acid, platinum-olefin complex, platinum-vinylsiloxane complex, and Pt(acac)₂, are preferable.

Inorganic fillers can also be added to the liquid rubber compositions used in the non-pneumatic tires of this invention to enhance physical properties. Some representative examples of inorganic fillers that can be used include calcium carbonate, talc, silica, carbon black, reinforcing silica and other ordinary inorganic fillers. However, in cases where the liquid rubber composition is cured, at least in part, by crosslinking by use of a hydrosilylation reaction, the influences on the hydrosilylation reaction should be taken into consideration in using such a filler. For instance, if the filler has a high content of absorbed moisture, the moisture will react with the curing agent, which can result in foaming during curing of the liquid rubber composition. When the filler contains a component capable of interfering with the hydrosilylation reaction, for example a nitrogen and/or sulfur atom, a reduction in curability or insufficient curing may result. Some fillers can have an influence on the storage stability of the curable composition. In using such an inorganic filler, it is important to confirm the influence of the inorganic filler on the curability and/or storage stability beforehand.

One or more of antioxidants, ultraviolet absorbers, pigments, surfactants and other additives can also be incorporated in the liquid rubber compositions employed in the non-pneumatic tires of this invention in appropriate amounts. Again, the influence of these agents on the cure reaction should also be taken into consideration. The elasticity of cured rubber products made with such liquid rubber compositions can typically be improved by curing the polymer with a peroxide or hydroperoxide curative and elasticity can be further increased by incorporating a liquid C₅ tackifier resin therein. By utilizing a C₅ tackifier resin, the elasticity of the cured rubber of the tire tread made can be increased without lowering the level of curative.

The C₅ liquid tackifier resins, if used, will typically have a weight average molecular weight which is within the range of about 600 to 1000 and are normally comprised of monomers containing 5 carbon atoms including but not limited to 2-methyl-2-butene, cis-piperylene, trans-piperylene, cyclopentene, and additional unsaturated hydrocarbon monomers containing from about 4 to about 18 carbon atoms. A liquid C₅ tackifier resin that is useful in the practice of this invention is commercially available from The Goodyear Tire & Rubber Company and is sold as Wingtack® 10 tackifier resin. It has a number average molecular weight of 660, a weight average molecular weight of 800, a glass transition temperature of −36° C. and a softening point of 10° C.

The amount of liquid C₅ tackifier resin added will depend upon the increase in elasticity that is being sought. Normally, a maximum elongation at break is attained by incorporating about 50 phr (parts per hundred parts by weight of rubber) of the liquid tackifier resins into the liquid polymer. Accordingly, in most cases, from about 1 to about 100 phr of the liquid tackifier resin will be incorporated into the liquid rubber composition. More typically, from about 10 phr to about 50 phr of the liquid tackifier resin will be mixed into the liquid polymer.

In still another embodiment, said recesses taper from the radially outer surface of the ring member in a radially inner direction, at least along radially outer portions of the recesses. Such a shape helps to provide a relatively wide recess opening towards the tread, while keeping the channel volume small. In case of using oxygen curable liquid rubber compositions, such an arrangement helps to increase the area of cured tread rubber. On the other hand, narrow channels help to limit the amount of liquid polymer material present in the channels. This is of particular advantage if liquid rubber compositions are changed in the reservoir, reducing thus the time it takes until the new composition forms tread portions of new material.

In still another embodiment, an inner diameter of the channels is within the range of 1 mm to 10 mm, preferably within the range of 2 mm to 5 mm.

In still another embodiment, sidewalls of the recesses have, at a radially outer portion of the recesses, a rough surface. The rough surface helps to ensure that the cured polymer composition is held better on the recesses' surface.

In still another embodiment, the radially outermost opening of a recess has a largest diameter of at least 10 mm but preferably less than 80 mm.

In still another embodiment, one or more of the recesses comprise a grid transversely extending across a radially outer side of the recesses and/or supporting the tread portions covering the recesses. Such a grid may further help to ensure the adhesion of the (cured) tread portions on the ring member. Depending on the thickness of the grid, liquid polymer material may still flow through the grid.

In still another embodiment, the ring member comprises a reinforced polymer material. The ring member may also be called a shear band as used in the field of non-pneumatic tires.

In still another embodiment, the hub portion is adapted to be mounted on a vehicle wheel hub. For instance, the hub portion may comprise a circle of through holes for receiving bolts or stay bolts for connecting the tire via the hub portion to a vehicle (the vehicle hub).

In still another embodiment, the tread portion is made of rubber material. As mentioned already above the rubber material or rubber composition is preferably oxygen curable. It may for instance be comprised of a blend of liquid high vinyl polybutadiene rubber, liquid high vinyl styrene-butadiene rubber, a C₅ tackifier resin and a filler. However, it is emphasized that one embodiment of the present application is focused on the construction of the tire rather than being specifically tied to the chemical composition of the liquid rubber composition employed in the tire.

In still another embodiment, a filler in the rubber composition is preferably synthetic spider silk. In particular, the composition may comprise spider silk in fibers. Such fibers may for instance have molecular lengths within the range of multiple millimeters such as 1 mm to 10 mm, and which are present as self-coiled material in the range of 0.1 μm to 200 μm. The fiber can be present as single-strand self-coiled material, or as multiple parallel-strands coiled material. The degree of coiling is dependent on the specific types and sequence of the constituting amino-acids. Such synthetic silk can consist of up to 90% of repetitive sequences of one amino-acid, spaced with sequences of other amino-acids, together with non-repetitive end-structures (terminal domains). The primary structure can thus be made of large non-polar and/or hydrophobic areas, which allows to have a good mixing potential with the non-polar/low-polar rubber-matrix. These large repetitive areas can form self-assembled semi-crystalline and/or crystalline domains, which confer the high mechanical strength of the synthetic silk structures. The primary structure of a synthetic spider silk may be thus composed of patterns of hydrophobic domains interspersed with hydrophilic domains. This alternating polarity-pattern allows the self-coiling based on interactions between polar groups, with the hydrophilic parts showing to the inside, and the hydrophobic side to the outside, thus conferring a hydro-phobic and/or non-polar behavior versus the non-polar/low-polar rubber-matrix. The specific types and sequence (primary structure) of the synthetic spider silk controls the secondary, tertiary and quaternary structure(s) of the silk. More specifically, cysteine amino-acid containing areas, which are protruding from the non-polar domains, allow as a sulfur-containing amino-acid, a sulfur-bonding with rubber-molecules from the matrix, should such classic sulfur-crosslinks being wished, as in classical hot and cold vulcanization. In particular, provision of such spider silk has the advantage of being present in the form of a coil, which is nevertheless a filament, able to form an interpenetrating network with the rubber-polymer matrix. Thus, the polymer-filament based filler is physically strongly bound into the rubber-matrix.

In another embodiment, the tread portions form rubber material studs extending out of the radially outer surface of the ring member. One could also describe the tire as a studded tire. However, such studs shall not be confused with ice studs made of metal material. Rather the studs according to the present embodiment are made of (cured) liquid rubber composition material.

In a second aspect of the invention, the invention is directed to a kit or tire kit comprising: the non-pneumatic tire of this invention and at least one liquid-filled capsule for use in conjunction with such non-pneumatic tires. The non-pneumatic tire is comprised of a hub portion having an opening for receiving a liquid-filled capsule, a ring member essentially concentrically arranged about the hub portion, a plurality of tread portions (or tread studs) radially extending out of a radially outer surface of the ring member, and a plurality of spokes extending from a radially outer surface of the hub portion to a radially inner surface of the ring member for supporting the ring member on the hub portion. Furthermore, said tire comprises a plurality of channels fluidly connecting the capsule when received in the opening of the hub portion, with radially inner sides of the tread portions. The kit comprises at least one liquid-filled capsule comprising a liquid, wherein the capsule is receivable in the opening of the hub portion for providing the channels with liquid upon insertion of the capsule into the hub portion.

The provision of capsules in such a kit also allows for providing liquid rubber compounds for different purposes such as winter compounds or summer compounds. In other words, the liquid rubber compositions can be formulated for making tire tread rubber that is designed for a specific season, for example tire tread rubber for tire that are primarily for use in summer weather conditions, winter weather conditions, or a combination of all weather conditions (an all-weather tire). Moreover, the rubber composition could be adapted to a (specific) location taking into account the local driving conditions, such as unpaved roads, typically driving speeds, quantity of rain, ice, snow, and/or humidity which may require a composition with focus on wet grip properties. In another alternative example, the composition could be adapted for use in high temperature areas such as in desert areas. A location could also require robust tread rubbers as for instance required in view of limited local road quality, thereby preferably resulting in use of tread rubbers with a focus on chip and chunk resistance. Apart from said seasonal and locational focus, choice of the liquid rubber composition or capsules may be in accordance with personal preferences or needs. For instance, some drivers may desire a rubber formulation optimized to low rolling resistance as they use the tires most time at constant speed over large distances on motorways. Other drivers may require a composition which is focused on grip as they drive frequently on countryside roads. Also new improved generations of compounds could be provided in such a manner to the tires. Thus, the tire could be “updated” according to the actual needs of the driver or in view of advanced developments in liquid rubber compositions.

In a third aspect of the invention, the present invention is directed to a method of servicing a tire in accordance with one or more of the aforementioned aspects and/or embodiments, the method may comprise one or more of the following steps:
A) identifying or determining a tire to be serviced;
B) providing the tire with liquid polymer composition.

In one embodiment, the step of identifying a tire to be serviced includes receiving a signal that a liquid polymer composition is almost depleted. For instance, such a signal may include one or more of: a message, a light signal, a sound signal.

In an embodiment, said step of identifying a tire to be serviced includes an analysis of one or more of the following parameters: driving locations, driving style, acceleration forces, breaking forces, weather conditions, season and/or date, wherein a liquid polymer composition to be provided to the tire is chosen based on said one or more parameters.

In another embodiment, the step of providing the tire with liquid polymer composition involves refilling a liquid polymer composition reservoir in the tire.

In another embodiment, the step of providing the tire with liquid polymer composition comprises replacing a capsule of liquid polymer composition in the tire with another capsule of liquid polymer composition.

In another embodiment, a new capsule installed in the tire comprises a different liquid polymer composition than the capsule removed from the tire, preferably based on one or more of the above mentioned parameters.

In another embodiment, the tire and/or an electronic vehicle system provides a message to one of the vehicle, the driver, and a vehicle fleet operator, indicating that the tires requires to be serviced.

The above second and third aspects may be combined with one or more embodiments already mentioned in relation to the described non-pneumatic tire and/or with the features mentioned in the detailed description of the invention.

### BRIEF DESCRIPTION OF THE DRAWINGS

The structure, operation, and advantages of the invention will become more apparent upon contemplation of the following description taken in conjunction with the accompanying drawings.

FIG. 1 is a schematic perspective view of a tire kit in accordance with an embodiment of the invention.

FIG. 2 is a partial perspective view of parts of the hub portion, spokes and the ring element of the tire of FIG. 1, in which the spokes are better visible.

FIG. 3 is a schematic side view of the hub, spokes, ring member assembly shown in FIG. 2.

FIG. 4 is a schematic cross section of a portion of the ring member with a recess covered by a tread portion and a liquid line attached to the recess.

### DETAILED DESCRIPTION OF THE INVENTION

The subject invention specifically discloses a non-pneumatic tire comprising: a hub portion; a ring member essentially concentrically arranged about the hub portion; a plurality of tread portions radially extending out of a radially outer surface of the ring member; a plurality of spokes extending from a radially outer surface of the hub portion to a radially inner surface of the ring member for supporting the ring member on the hub portion; and a plurality of channels fluidly connecting the hub portion with radially inner sides of the tread portions. In one embodiment of this invention the hub portion comprises a reservoir for receiving a liquid, the reservoir being in fluid communication with the plurality of channels. In another embodiment of the subject invention the spokes have rod-like shapes.

The present invention also reveals a tire kit comprising: (A) a non-pneumatic tire comprising a hub portion comprising an opening for receiving a liquid-filled capsule, a ring member essentially concentrically arranged about the hub portion, a plurality of tread portions radially extending out of a radially outer surface of the ring member, a plurality of spokes extending from a radially outer surface of the hub portion to a radially inner surface of the ring member for supporting the ring member on the hub portion, and a plurality of channels fluidly connecting the capsule with radially inner sides of the tread portions when received in the opening of the hub portion; and (B) a liquid-filled capsule receivable in the opening of the hub portion for providing the channels with liquid upon insertion of the capsule into the hub portion.

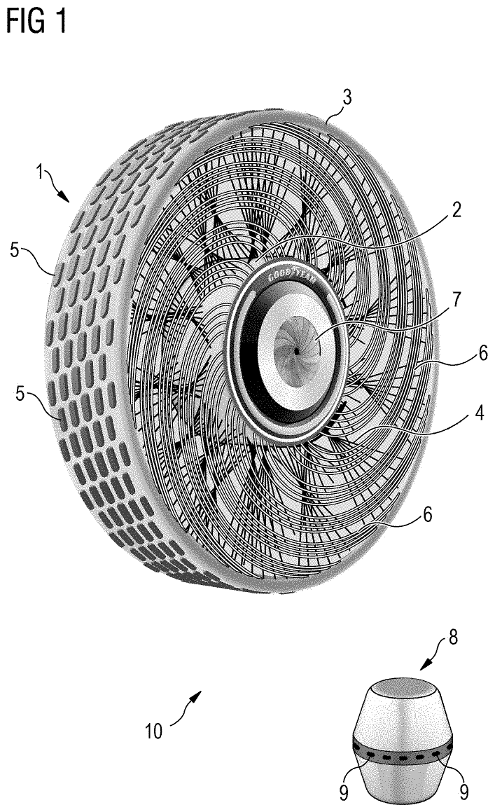

FIG. 1 shows a tire kit 10 comprising a non-pneumatic tire 1 and a refilling capsule 8, in accordance with a first embodiment of the invention. The tire 1 comprises a hub portion 2, a ring member 3, a plurality of spokes 4 supporting the ring member 3 on the central hub portion 2. Furthermore, the tire 1 comprises tread portions 5 extending radially out of the ring portion 3. The hub portion 2 is in fluid communication with a radially lower side of the tread portions 5 via liquid lines 6. The hub portion 2 comprises a (closable) opening 7 which is adapted to receive a capsule 8 which is insertable into the opening 7.

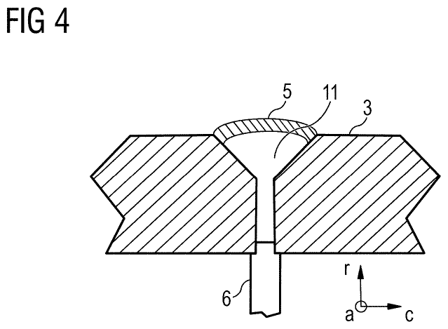

Said capsule 8 comprises a liquid polymer composition which is supplied to the liquid lines 6 or tubes upon insertion of the capsule 8 into the opening 7 of the hub portion 2. In particular, the opening 7 may be capable of being closed, such as by an iris shutter or door. While the liquid lines 6 have been schematically shown in FIG. 1 only in an axially outer plane perpendicular to the axis of rotation of the tire 1, such liquid lines 6 are preferably also provided at an axially central position of the tire 1, i.e. in one or more planes essentially perpendicular to the axis of rotation of the tire 1 between the axially outer edges of the tire 1, such as adjacent or essentially in the equatorial plane of the tire 1. Moreover, the liquid lines 6 extend in the depicted embodiment in a spiral manner. In an alternative embodiment, such liquid lines 6 could also extend essentially in a radial direction or in other shapes. The terms composition and compound are used interchangeably herein. In a preferred embodiment, the capsule 8, i.e. the liquid polymer composition therein is under high pressure forcing the liquid rubber composition out of the capsule 8 as soon as it is received in the opening 7 of the hub portion 2. In particular, the capsule 8 may have one or more closable apertures 9 which are brought into liquid communication with the liquid lines 6 upon insertion of the capsule into the opening 7. Preferably, one or more check valves (not shown) avoid that liquid rubber composition material may flow back into the capsule 8 once the capsule 8 is removed again from the tire 1. Alternatively, or in addition, the tire 1 may comprise pressuring means (not shown), e.g. a pump, such as an electrical, peristaltic or hydraulic pump which forces liquid out of the capsule 8 and into the liquid lines 6. The liquid lines 6 supply liquid rubber composition to the ring member 3. As is illustrated in FIG. 4 the liquid polymer is pushed into recesses 11 in the ring member 3.

The spokes 4 of the tire may have elongated shapes, in particular rod-like shapes and may be made of carbon fiber-based material.

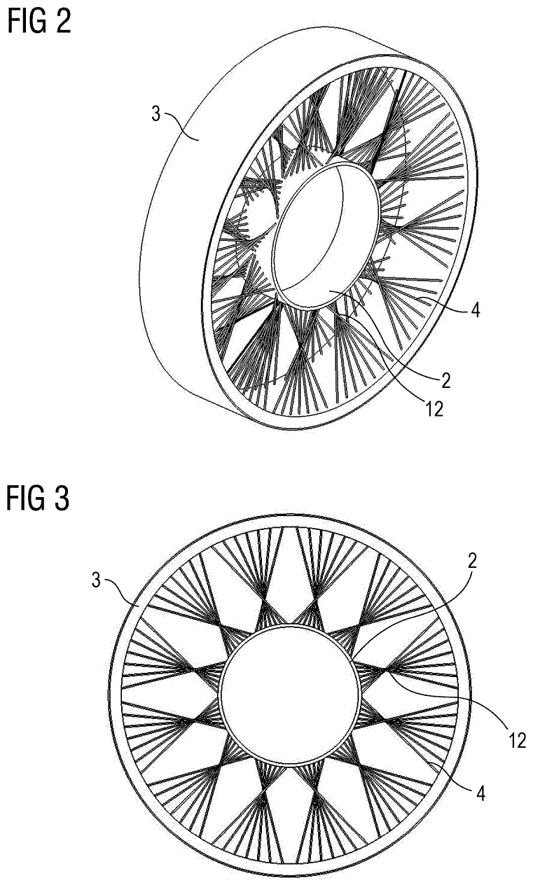

FIG. 2 shows a schematic perspective view of an outer shell of the tire hub portion 2, the spokes 4 and the ring member 3. In particular, the tire hub portion 2 has in this present and non-limiting embodiment an essentially cylindrical shape. The inner diameter of the ring member 3, measured in the radial direction, is preferably within a range of two to four times the radially outer diameter of the hub portion 2.

As shown in FIGS. 2 and 3, the spokes 4, which are preferably made of carbon fiber-based material, are arranged in 12 pairs of groups about the circumference of the tire 1. The spokes 4 extend from the radially outer surface of the hub portion 2 to the radially inner surface of the ring member 3. Each pair of groups consists of a first group of spokes 4 extending from a line adjacent and along a first axially outer edge of the ring member 3 towards the hub portion 2, wherein the spokes 4 cross beside each other adjacent a crossing point 12 between the hub portion 2 and the ring member 3 and further extend towards and onto the hub or hub portion 2. As shown in FIG. 2, the spokes 4 connect to the hub portion 2 at axial positions which are closer to the axial center of the hub portion 2 than the axial positions at which the spokes 4 of the first group are attached to the ring member 3. The second group of spokes 4 of the same pair (each group of the pair being essentially arranged at the same circumferential position or angle) extends from a line adjacent and along a second axially outer edge of the ring member 3 (axially opposite to said first edge) towards the hub portion 2. The spokes 4 of the second group cross beside each other adjacent a common crossing point between the hub portion 2 and the ring member 3 and further extend towards and onto the hub portion 2. Again, the spokes 4 connect to the hub at axial positions which are closer to the axial center of the hub portion 2 than the axial position at which the spokes 4 of the second group are attached to the ring member 3. Such an arrangement may improve the stiffness of the tire 1 with regard to lateral forces.

Moreover, as shown in FIG. 3, the spokes 4 of a group (sharing a common crossing point 12) are preferably attached to the hub portion 2 along a non-straight line extending in the axial and circumferential directions. Such an arrangement further improves stability with regard to lateral forces. Preferably, the crossing points 12 of all pairs have a radial distance to the radially outer surface of the hub portion 2 which is less than 50%, more preferably within the range of 25% to 45%, of the radial distance between the radially outer side of the hub portion 2 and the radially inner side of the ring member 3.

The suggested construction leaves a space axially between both groups of a pair of groups of spokes 4. By such a construction it is possible to provide liquid lines 6 for liquid rubber material from the hub portion 2 to the ring member 3 axially between the groups of spokes 4. Thus, the spokes 4 protect the liquid lines 6 against mechanical damages. The ring member 3 comprises also openings or in other words recesses for allowing the liquid lines 6 to be fluidly connected to the recesses in the ring member 3, thereby providing the tread portions 5 with liquid polymer composition from below.

FIG. 4 shows a schematic cross section of a recess 11 provided in the ring member 3 for allowing the liquid rubber composition to be provided to the radially lower surface of a tread portion 5. The recess 11 has a first portion with a cross-section tapering in the inner radial direction. The surface of the tapering portion may be roughened so as to provide a better connection between the cured rubber composition and the walls of the recess 11. The liquid rubber composition is pressed through the liquid line 6 and from a radially inner position of the recess 11 towards a radially outer portion of the recess 11. By reaction with oxygen (typically oxygen present in ambient air), the rubber composition cross-links and forms a cured tread portion layer. It is remarked that oxygen will also diffuse through the crosslinked rubber layer so that constantly new rubber is cured keeping an essentially constant thickness of the tread portion 5.

In order to further support the cured tread portions 5 against lateral and radial forces, a supporting grid (e.g. made of thermoplastic or metal material) may be provided in the tapering portion of the recess. Such a grid may essentially extend in a circumferential direction c and an axial direction a. The terms axial, radial or circumferential directions (a, r, c), are used herein as commonly understood in the tire art. In particular, a reference to an axial direction means a direction in parallel to the axis of rotation of the tire. A reference to the circumferential direction is a direction concentric about the axis of rotation of the tire and/or in parallel to an equatorial plane of the tire. The radial direction is perpendicular to the axis of rotation of the tire.

During manufacturing of a tire 1, it is possible to cover the recesses 11 by a semipermeable foil or membrane (not shown) allowing the liquid rubber composition material to move through the channels until touching said membrane covering the recesses 11 on the radially outer surface of the ring member 3. Then oxygen can diffuse through the membrane and create a cured tread portion layer below the membrane. After forming of a stable tread portion layer, the semipermeable membrane may be removed and optionally replaced by a non-oxygen-permeable foil for storage. Alternatively, the semipermeable membrane may be covered by a nonpermeable foil for storage. Depending on the compound, also storage without and addition foil may be possible.

While certain representative embodiments and details have been shown for the purpose of illustrating the subject invention, it will be apparent to those skilled in this art that various changes and modifications can be made therein without departing from the scope of the subject invention.

What is claimed is:

1. A non-pneumatic tire comprising: a hub portion; a ring member essentially concentrically arranged about the hub portion; a plurality of tread portions radially extending out of a radially outer surface of the ring member; a plurality of spokes extending from a radially outer surface of the hub portion to a radially inner surface of the ring member for supporting the ring member on the hub portion; and a plurality of channels fluidly connecting the hub portion with radially inner sides of the tread portions.

2. The non-pneumatic tire of claim 1 wherein the hub portion comprises a reservoir for receiving a liquid, the reservoir being in fluid communication with the plurality of channels.

3. The non-pneumatic tire of claim 1 wherein the spokes have rod-like shapes.

4. The non-pneumatic tire of claim 1 wherein at least some of the channels extend between the spokes from the hub portion to the radially inner sides of the tread portions.

5. The non-pneumatic tire of claim 1 wherein one or more of the spokes are hollow and form portions of the channels.

6. The non-pneumatic tire of claim 1 wherein the channels comprise a plurality of flexible tubes extending from the hub portion to the ring member.

7. The non-pneumatic tire of claim 1 wherein the spokes are made of one or more of carbon fiber composite materials, polymeric materials or metals.

8. The non-pneumatic tire of claim 2 wherein the tire further comprises at least one check valve adapted to avoid flow back of liquid from the channels back into the reservoir.

9. The non-pneumatic tire of claim 2 wherein the reservoir comprises or is an exchangeable capsule.

10. The non-pneumatic tire of claim 9 wherein the capsule comprises at least one opening which is adapted to be closable to fluid communication with the channels when inserted in the hub portion.

11. The non-pneumatic tire of claim 1 wherein the tire comprises pressuring means for pumping liquid out of the reservoir and through the channels.

12. The non-pneumatic tire of claim 1 wherein the ring member comprises a plurality of recesses extending from a radially outer surface of the ring member through the ring member, wherein each recess is covered, at its radially outer portion, by at least one of the tread portions, and wherein each of the recesses is, at a radially inner portion, in fluid communication with at least one of the channels.

13. The non-pneumatic tire of claim 12 wherein the recesses at least partially taper from the radially outer surface of the ring member in a radially inner direction.

14. The non-pneumatic tire of claim 12 wherein sidewalls of the recesses have, at a radially outer portion of the recesses, a rough surface.

15. The non-pneumatic tire of claim 12 wherein one or more of the recesses comprise a grid transversely extending across a radially outer side of the recesses and supporting the tread portions covering the recesses.

16. The non-pneumatic tire of claim 1 wherein the ring member comprises a reinforced polymer material.

17. The non-pneumatic tire of claim 1 wherein the hub portion is adapted to be mounted to a vehicle wheel hub or a rim.

18. The non-pneumatic tire of claim 1 wherein each tread portion is made of rubber material.

19. The non-pneumatic tire of claim 1 wherein the tread portions form rubber material studs extending out of the radially outer surface of the ring member.

20. A tire kit comprising:
A) a non-pneumatic tire comprising:
a hub portion comprising an opening for receiving a liquid-filled capsule,
a ring member essentially concentrically arranged about the hub portion,
a plurality of tread portions radially extending out of a radially outer surface of the ring member,
a plurality of spokes extending from a radially outer surface of the hub portion to a radially inner surface of the ring member for supporting the ring member on the hub portion, and
a plurality of channels fluidly connecting the capsule with radially inner sides of the tread portions when received in the opening of the hub portion; and
B) a liquid-filled capsule receivable in the opening of the hub portion for providing the channels with liquid upon insertion of the capsule into the hub portion.
